(19) United States
(12) Patent Application Publication
(10) Pub. No.: US 2026/0370990 A1
(43) Pub. Date: Nov. 19, 2026

(54) IMPLEMENTING PERTURBATION TECHNIQUES TO PROVIDE FIBER MAPPING IN OPTICAL SYSTEMS

(71) Applicant: VIAVI SOLUTIONS INC., Chandler, AZ (US)

(72) Inventors: Christopher Daniel BOBEK, Fishers, IN (US); Raleigh Benton Stelle, IV, Indianapolis, IN (US)

(73) Assignee: VIAVI SOLUTIONS INC., Chandler, AZ (US)

(21) Appl. No.: 19/207,916

(22) Filed: May 14, 2025

(51) Int. Cl. H04Q 11/00; G01D 5/353; H04L 49/111

(52) U.S. Cl. CPC H04Q 11/0062; G01D 5/3537; H04L 49/111; H04Q 11/0005; H04Q 2011/0007; H04Q 2011/0083

(57) ABSTRACT

According to examples, systems and methods for implementing perturbation techniques in an optical system to enable fiber mapping. An example includes a transmitter to transmit a fiber optic signal from a port of the transmitter through a fiber, a fiber perturbation component to provide perturbation of the fiber optic signal during propagation through the fiber, and a receiver to receive the fiber optic signal at a port of the receiver, wherein the receiver is to detect and analyze the perturbation of the fiber optic signal to determine if the port of the receiver is an appropriate port for the fiber optic signal to be mapped to.

### TECHNICAL FIELD

This patent application relates generally to testing of communication networks, and more specifically, to implementing perturbation techniques in an optical system to enable fiber mapping.

### BACKGROUND

A fiber optic communication network may include one or more optical components. Examples may include optical connectors, optical splices, optical couplers, and optical switches. These optical components may be coupled via use of one or more fiber optic cables. A fiber optic cable may include one or more optical fibers to transmit optical signals from a source to a destination.

It may be appreciated that when emitting or distributing signals via one or more channels, it may be necessary to ensure that signal transmission requirements are met. Furthermore, in some instances, it may be necessary to test components and cables of a fiber optic communication network to ensure proper operation. Testing may be performed prior to installation or during operation.

Ensuring that fiber optic signals are directed from an initial point in a communication network to a (appropriate) end point in the communication network may be referred to as “fiber mapping.” However, it may be appreciated that implementation of current fiber mapping techniques may often be costly and/or time-consuming.

### BRIEF DESCRIPTION OF DRAWINGS

Features of the present disclosure are illustrated by way of example and not limited in the following figures, in which like numerals indicate like elements. One skilled in the art will readily recognize from the following that alternative examples of the structures and methods illustrated in the figures can be employed without departing from the principles described herein.

FIG. 1 illustrates a configuration of a single mode fiber optic cable, according to examples described herein.

FIG. 2 illustrates a configuration of a multimode fiber optic cable, according to examples described herein.

FIGS. 3A-3B illustrate an optical signal transfer via a fiber in a compliant launch condition, according to examples described herein.

FIG. 4 illustrates a multi-fiber bundle including a plurality (or “bundle”) of fibers, according to examples described herein.

FIG. 5 illustrates a transmission system transmitting a plurality of optical signals via a multi-fiber bundle, according to examples described herein.

FIG. 6 illustrates a fiber optic arrangement where directed bending of a fiber may cause attention in a fiber optic signal, according to examples described herein.

FIGS. 7A-7C illustrate aspects of a perturbation component, according to examples of the present disclosure.

FIGS. 8A-8E illustrate aspects of a perturbation component, according to examples of the present disclosure.

FIGS. 9A-9B illustrate aspects of a system including a perturbation component, according to examples of the present disclosure.

FIGS. 10A-10B illustrate systems having optical sources and optical fibers configured to enable distinctive identification of a fiber optic signal, according to examples described herein.

FIG. 11 illustrates a system wherein a plurality of fibers having different lengths are implemented to enable distinctive identification of a fiber optic signal, according to examples described herein.

FIG. 12 illustrates a method for implementing perturbation techniques in an optical system to enable fiber mapping, according to examples of the present disclosure.

### DETAILED DESCRIPTION

For simplicity and illustrative purposes, the present disclosure is described by referring mainly to examples thereof. In the following description, details are set forth in order to provide an understanding of the present disclosure. It will be readily apparent however, that the present disclosure may be practiced without limitation to these details. In other instances, some methods and structures have not been described in detail so as not to unnecessarily obscure the present disclosure.

Throughout the present disclosure, the terms “a” and “an” are intended to be at least one of a particular element. As used herein, the term “includes” means includes but not limited to, the term “including” means including but not limited to. The term “based on” means based at least in part on.

Data centers enable sharing of data and content and provide storage and backup for redundancy, and typically house compute and storage resources for applications, data, and content. A data center typically includes various electronic equipment to support network communication(s).

The electronic equipment of a data center typically connects to wireline networks, which may be comprised of fiber optic cables and coaxial cables. The sharing may take place between, for example, two data centers a few miles apart or two data centers connected via trans-oceanic lines.

One technology that may be utilized to enable sharing across data centers is Data Center Interconnection (DCI) technology. DCI may be utilized to implement high-speed data packet transfer for two or more data centers over various distances.

It may be appreciated that data center operations may depend on a wide range of design and logistical variables. Examples of these variables may include, among others, a location of the data center(s), distance between data centers, bandwidth, cost, and capacities of local service providers. Furthermore, it may be appreciated that, in many instances, fiber optic cables are essential for facilitating data center communications.

Fiber optic cables typically support superior transmission speeds over longer distances (e.g., when compared to copper cabling). As a result, fiber optic cables have become a primary means for connecting data centers.

Typically, a fiber optic cable may contain one or more glass strands, wherein each of the glass strands may be enclosed in a protective coating (or “cladding”). These glass strands are typically thin, in the order to five (5) to fifty (50) microns (μm) in diameter. Also, these glass strands may be bundled together and enclosed within an outer jacket.

Each fiber may comprise a glass core that may transmit fiber optic signals (e.g., at specific wavelengths). These fiber optic signals are encoded with data and launched into the fiber core by transmitters at one end of the fiber cable. The light pulses may be propagated via a glass core to receivers that may decode the light pulses into digital data.

As used herein, a “data rate” may measure how much data a fiber optic cable may transmit in a given amount of time. Data rates may typically be measured in megabits per second (Mb/s) or gigabits per second (Gb/s). So, at a signal rate per lane of one hundred (100) Gb/s, an 8-fiber multimode fiber optic cable can support a data rate of four hundred (400) Gb/s, with four fibers transmitting at one hundred (100) Gb/s and four fibers receiving at one hundred (100) Gb/s.

An amount of data that a fiber optic cable may send may depend on multiple factors. Examples of these factors may include a type of the fiber, an application or setting in which the fiber may be deployed, and associated equipment that the fiber may be functioning with.

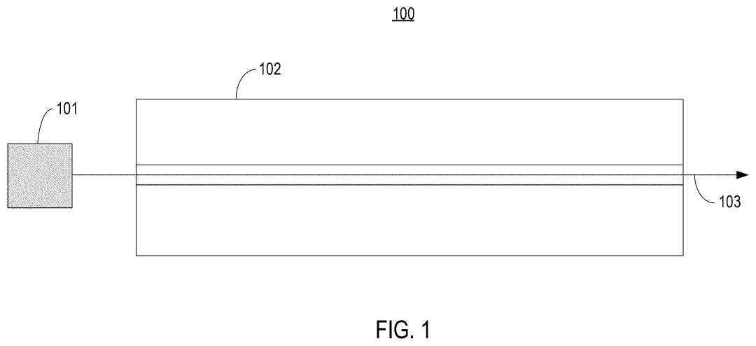

Fiber optic cables may come in multiple types. For example, a first type of fiber optic cable may be a “single mode” fiber optic cable. In a single mode fiber optic cable, light may travel in a single path a length of the fiber optic line. Typically, single mode fiber optic cables do not offer any limit on modal bandwidth(s), and have a relatively smaller core (e.g., approximately ten (10) microns (μm) in diameter). Also, transmitting fiber optic signals in one mode also allows single mode fiber optic cables to implement a range of wavelengths. By way of example, single mode fibers may use several wavelengths, typically in the range of twelve hundred seventy (1270) to sixteen hundred ten (1610) nanometer (nm) wavelengths. FIG. 1 illustrates a configuration 100 including a single mode fiber optic cable, according to examples described herein. In some examples, a light source 101 may emit a (single) fiber optic signal 103 through a single mode fiber optic cable 102. As discussed above, the single mode fiber optic cable 102 may contain one or more glass strands, which may be enclosed in a protective cladding.

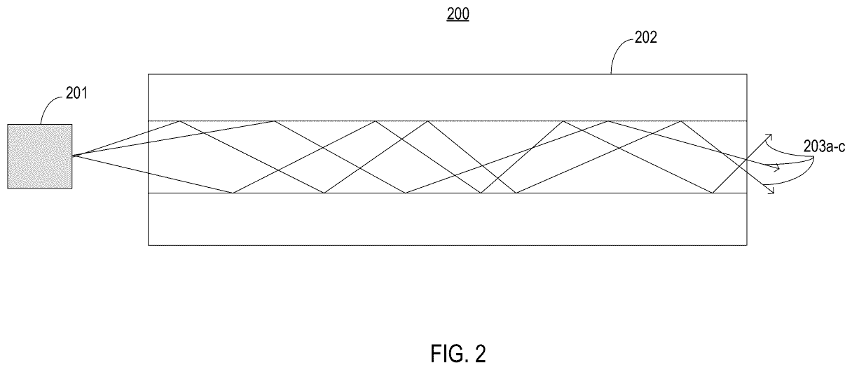

A second type of fiber optic cable may be a “multimode” fiber optic cable. Multimode fiber optic cables typically have cores with larger diameters (e.g., approximately fifty (50) microns (μm) or sixty-two point five (62.5) micron (μm)). A multimode fiber optic cable may transmit light in multiple paths. By way of example, multimode fiber optic cables may typically transmit at eight hundred fifty (850) and thirteen hundred (1300) nanometer (nm) wavelengths. FIG. 2 illustrates a configuration 200 of a multimode fiber optic cable, according to examples described herein. In some examples, a light source 201 may emit a (multiple) fiber optic signals 203a-c through a fiber optic cable 202 (e.g., a multimode cable). As discussed above, the fiber optic cable 202 may contain one or more glass strands, which may be enclosed in a protective cladding.

In order to ensure that the fiber optic signal is being transmitted properly, the fiber optic cable may be tested for transmission characteristics. For example, during testing of a fiber, it may be necessary to ensure that transmission of the fiber optic signal is uniform and proportionate. For these reasons, a fiber may typically be tested during manufacture (i.e., prior to deployment), and/or after deployment in the field (e.g., in a data center) to ensure that propagation and distribution of light through a fiber channel (i.e., a fiber) is proper.

To ensure accurate and repeatable measurements during testing, a “launch condition” of a light source may be determined. Specifically, a launch condition of a light source may represent how and where the light is distributed within the fiber. Providing appropriate launch conditions may be critical for minimizing signal loss and ensuring accurate measurements in optical fiber systems. In some instances, a condition may occur where an appropriate range of power in one or more modes may be transmitted. This may be referred to a “compliant” launch condition.

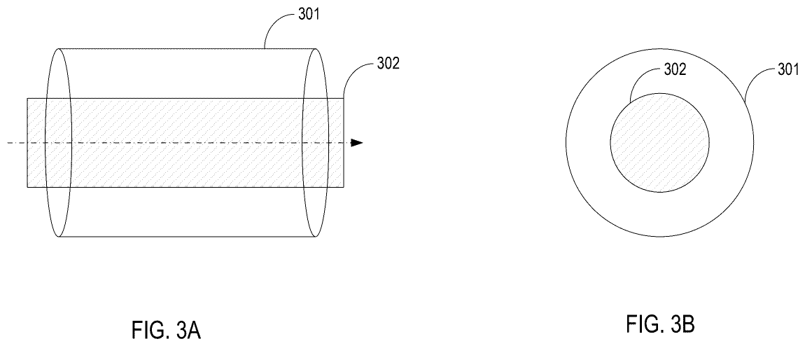

FIGS. 3A-3B illustrate an optical signal transfer via a fiber in a compliant launch condition, according to examples described herein. Specifically, FIG. 3A illustrates a side view of a fiber 301 through which an optical signal 302 (e.g., a laser) may be transmitted. FIG. 3B illustrates a cross-sectional view of the fiber 301 through which the optical signal 302 may be transmitted. By ensuring a compliant launch, increased loss values may be detected when an (actual) problem may be present (e.g., with a cable, a connector, etc.).

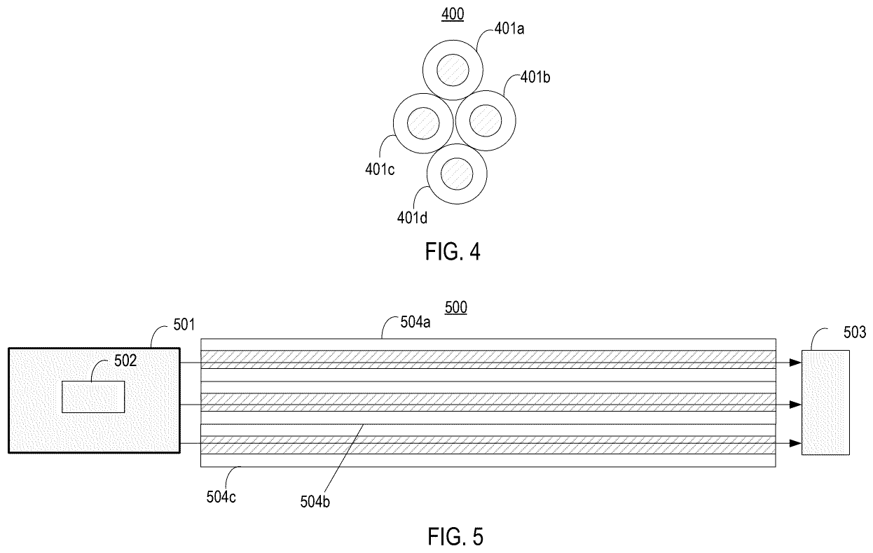

In some instances, one or more optical fibers may be coupled together in order to enable transmission of light through several cores simultaneously. This may be referred to as a multi-fiber “bundle,” and may increase data transmission capacities in fiber optic networks. FIG. 4 illustrates a multi-fiber bundle 400 including a plurality (or “bundle”) of fibers 401a-401d, according to examples described herein. In various examples, bundles of four (4), eight (8), twelve (12), twenty-four (24) may be implemented in, for example, a single multi-fiber connector.

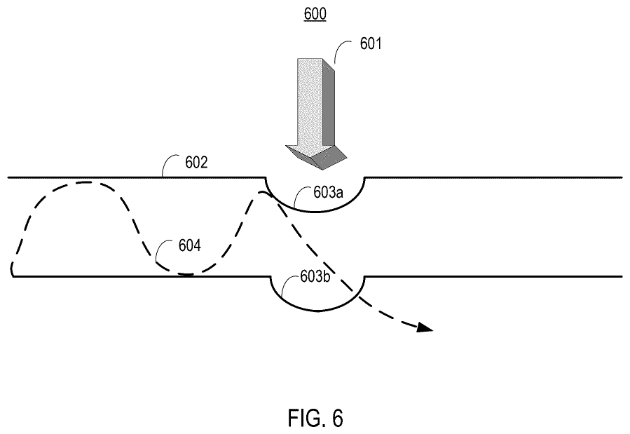

FIG. 5 illustrates a transmission system 500 transmitting a plurality of optical signals via a multi-fiber bundle, according to examples described herein. In some examples, a transmitter 501 may include a light source 502 that may transmit a plurality of fiber optic signals over a multi-fiber bundle including the fibers 504a-504c towards a receiver 503.

To maintain transmission integrity, it may be important to ensure that each of the fiber optic signals propagating the fibers 504a-504c is received at an appropriate end point of the receiver 503. In particular, it may be critical to ensure that a fiber optic signal originating at a transmitting end and propagating through the multi-fiber bundle is received at an appropriate (i.e., intended) end point on a receiving end. Furthermore, it may be necessary to ensure that a signal is emitted or distributed with sufficient transmission integrity, and unwanted transmission loss or variation is minimized.

In some instances, techniques associated with ensuring that communication (e.g., fiber optic signals) are directed from an initial point in a communication network to a (appropriate) end point in the communication may be referred to as “mapping.” So, in some instances related to a multi-fiber bundle, it may be critical to ensure that a fiber optic signal for a first fiber in the multi-fiber bundle is routed to a correct destination, a second fiber in the multi-fiber bundle is routed to a correct destination, and so on.

In some instances, to ensure that fiber mapping is implemented, communication between a source component (e.g., the transmitter 501) and a destination component (e.g., the receiver 503) may be enabled via a (e.g., dedicated) communications channel. The communications channel may be implemented to, among other things, synchronize the source component and the destination component, and/or communicate information related to measurement and testing of fibers (e.g., the fibers 504a-504c).

Various techniques may be implemented to ensure that fiber mapping for a multi-fiber bundle is properly implemented. One such technique may include implementation of switch, such as a micro-electronic mechanical system (MEMS)-based mirror switch. In some examples, a MEMS-based mirror switch may utilize a motor to move a mirror to direct a fiber optic signal towards a particular fiber of the multi-fiber bundle. Furthermore, in some examples, the MEMS-based mirror switch may be used to route a fiber optic signal from a first fiber in a multi-fiber bundle to a second fiber (e.g., destined to a remote endpoint) in the multi-fiber bundle.

However, it may be appreciated that implementation of a MEMS-based switch may, in many instances, be costly. Furthermore, implementation of a MEMS-based mirror switch may be (relatively) time-consuming, as it may require slow and/or careful scanning off some or all of the fibers in the multi-fiber bundle.

In addition, implementing a MEMS-based mirror switch may require a new settling time each time the MEMS-based mirror switch may move to a different fiber port at the output. Specifically, this may require individualized (i.e., sequential) detection(s) and measurement(s) to verify that each signal is properly propagated. In some instances, this can be a prohibitively slow process. Other issues may arise in implementing fiber mapping as well. For example, when a multi-fiber bundle is cross-wired, signal propagation through the multi-fiber bundle may be impaired.

In these instances, it may also be important to readily determine that that an impairment is present and fiber optic signals are not being properly transmitted. Accordingly, implementation of inexpensive and/or minimally imposing techniques for fiber mapping is beneficial.

Systems and methods are directed to implementing perturbation techniques in an optical system to enable fiber mapping. As used herein, “perturbation” may include any modification or variation of an aspect of the optical system to enable fiber mapping. These aspects of the optical system may include, but are not limited to, any aspects associated with one or more optical sources, one or more optical fibers, and one or more fiber optic signals of the optical systems.

Various perturbation techniques are discussed in further detail below. In some examples and as will be discussed in further below, the perturbation techniques may be implemented to distinctively identify a fiber optic signal in order to enable fiber mapping. It may be appreciated that these techniques may be implemented for a variety of optical sources (e.g., lasers, light-emitting diodes LEDs, etc.), in single-fiber and multi-fiber arrangements, and for single mode and multi-mode fiber optic signals.

In some examples, perturbation techniques may include introduction of an attenuation in a fiber optic signal, wherein detection of the attenuation (e.g., on a receiving end) may enable identification of the fiber optic signal and/or a determination if the fiber optic signal has been properly mapped. In other examples, the perturbation technique may include modification (e.g., via filtering) of a fiber optic signal, wherein aspects and/or results of the modification may be detected to enable identification of the fiber optic signal and/or a determination if the fiber optic signal has been properly mapped. In still other examples, the perturbation techniques may include variation (e.g., via movement) of an optical source or a fiber, wherein aspects and/or results of the modification may be detected to enable identification of the fiber optic signal and/or a determination if the fiber optic signal has been properly mapped.

In some examples, to enable these techniques, it may be necessary to determine (i.e., measure) a “steady state” of the fiber optic signal, prior to the perturbation. In addition, another measurement, after the perturbation, may be required as well. In addition, in various examples of the present disclosure, communication(s) between various components of an optical system (e.g., to identify a particular fiber optic signal) may be facilitated during transmission of a fiber optic signal.

Accordingly, the systems and methods described herein may require relatively little precision in implementation (e.g., compared to a MEMS-based mirror switch). Furthermore, the systems and methods may enable cost-effective and easily-implementable solutions as well.

In some instances, upon sufficient bending of a fiber carrying a fiber optic signal, a portion of the light that typically may propagate through the fiber may be “lost.” In particular, in some examples, the portion of the light may bounce off an inner layer of the fiber, and may result in a power loss (i.e., attenuation) of the fiber optic signal.

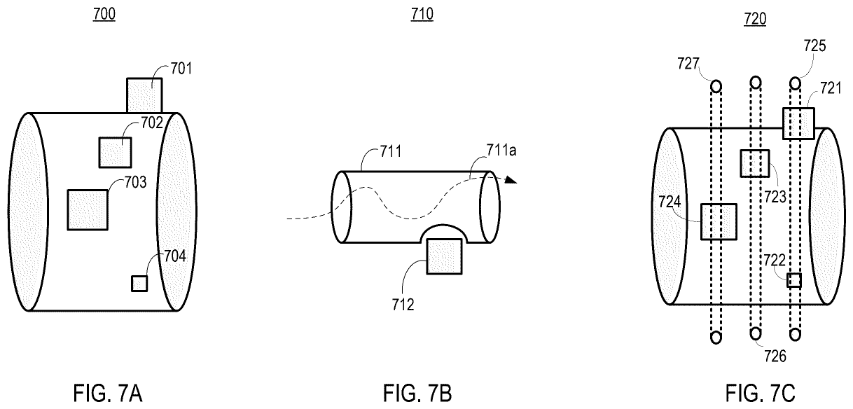

FIG. 6 illustrates a fiber optic arrangement 600 where directed bending of a fiber may cause attention in a fiber optic signal, according to examples described herein. As used herein, a “directed” bending of a fiber may include any causing of a fiber in an optical system to change shape. Examples of techniques that may produce such a bending may include, but are not limited to application of force, change in temperature, etc.

So, in some examples, an application of pressure 601 via physical contact may cause directed bending(s) 603a, 603b in a fiber 602. In some examples, the directed bending 603a, 603b of the fiber 602 may cause some light on the fiber optic signal 604 to be lost, and may cause attenuation of the fiber optic signal 604. Specifically, in some examples, upon sufficient bending of the fiber 602, light from the fiber optic signal 604 may be (re)directed away from a core of the fiber 602 and toward an inner lining of the of the fiber 602, thereby dispersing into a jacket portion of the fiber 602. As such, in some instances, as the fiber optic signal 604 may propagate through the fiber 602, light may be lost, and the fiber optic signal 604 may attenuate.

In some instances, this perturbation of a fiber optic signal may cause an attenuation that may be measured. Additionally, in some instances, a bending of a fiber carrying a fiber optic signal may cause an attenuation in the fiber optic signal that may be used to identify the fiber optic signal. Specifically, as will be discussed in further detail below, a directed attenuation of the fiber optic signal (via a directed bending of the associated fiber) may be used to create a “signature” attenuation that may be used to identify a fiber optic signal and to verify that the fiber optic signal is received at an appropriate destination. As used herein, a “signature” attenuation may include a predetermined and/or anticipated attenuation produced in a fiber optic signal that may be used to identify the fiber optic signal.

In some examples, attenuation of a fiber optic signal may be compared to a steady state condition of the fiber optic signal to identify the fiber optic signal, based on the attenuation characteristics. In particular, in some examples, a power meter may be used to measure and/or monitor attenuation of the fiber optic signal propagating the fiber, and to verify that the fiber optic signal passing through the fiber is indeed the correct fiber optic signal.

In some examples, a characteristic, periodic, and/or sequential drop in an amount of light in a fiber of a multi-fiber bundle (e.g., read by a power meter located at a destination) may identify and verify a (particular) fiber optic signal. In some examples, when a light source may be activated, and a fiber optic signal may be passed through one or more fiber optic cables being perturbed, the associated attenuations may be measured and/or monitored to verify proper fiber mapping of the fiber optic signal.

Accordingly, in this manner, one or more perturbation techniques may be used to detect attenuation in a plurality of fiber optic signals propagating through a plurality of fibers, such as that found in a multi-fiber arrangement. So, in an example where a fiber optic signal may originate at and propagate through a first fiber in a multi-fiber bundle, and destined for a third fiber in the multi-fiber bundle, a power meter located the destination may utilize a signature attenuation to determine if the fiber optic signal was received (correctly) at the third fiber, or (incorrectly) at a different fiber of the multi-fiber bundle. Furthermore, it may be appreciated that, directed bending may be repeated (sequentially) in time across a collection of fibers (e.g., a multi-fiber bundle) in a known sequence and mapped to a remote endpoint to determine an exact mapping from one port at a source to another one at the destination.

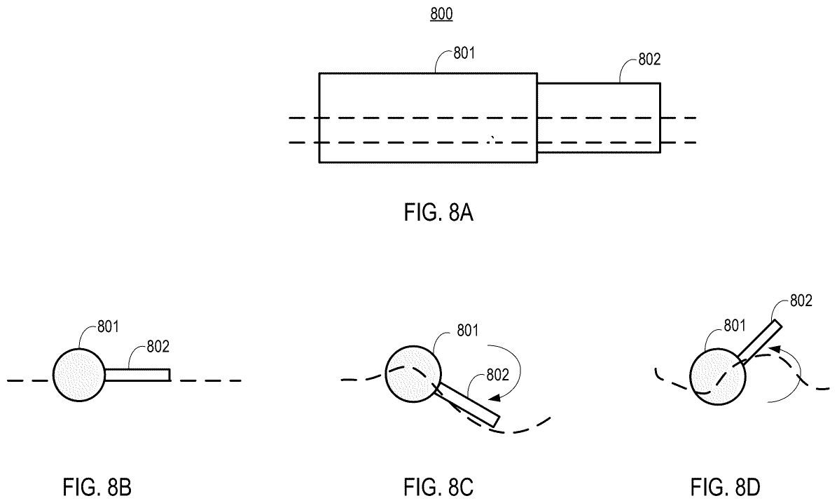

FIGS. 7A-7C illustrate aspects of a perturbation component 700, according to examples of the present disclosure. As used herein, a “perturbation component” may include any device, technique, or component that may be used to create a perturbation in an optical system. In some examples, as illustrated in FIG. 7A, the perturbation component 700 may be a solid body with one or more protrusions 701-704 on a surface of the perturbation component 700.

In some examples, as illustrated in FIG. 7B, a protrusion 712 may be located proximately to a fiber 711 carrying a fiber optic signal 710a. In particular, as the protrusion 712 may be placed proximate to and/or brought in contact with the fiber 711, the protrusions may cause a directed bending of the fiber 711, so as to cause the fiber optic signal 711a to attenuate during propagation (e.g., similar to the example described in FIG. 6). In some examples, the directed bending may take place on a first side of the fiber 711 (only), while in other examples, the directed bending may take place on both a first side and an opposite side of the fiber 711. Accordingly, the one or more protrusions 701-704 may be implemented to produce one or more sequential and/or repeating directed bending(s) of the fiber 710 over time, which may be used (e.g., as a signature) to identify the associated fiber 710 and/or fiber optic signal 710a.

In some examples, a perturbation component may be rotated by a motor, where each of the one or more protrusions may be contacted with the fiber to cause a (sequential) directed bending of the fiber. This may, in turn, be used to generate an identifiable (i.e., measurable) attenuation in the fiber optic signal, in real-time. In other examples, the perturbation component may be moved (e.g., rotated) via implementation of an actuator component or a micro-electromechanical system (MEMS) component.

In some examples, implementation of the perturbation component, and other similar perturbation component(s), may cause a sequence of temporary, directed bends in the fiber. That is, in some examples a directed bend may be followed by a restoration of the fiber.

As discussed above, in some examples, one or more fibers of a multi-fiber bundle may be measured (continuously), and the measurements may be used anticipate and/or identify (signature) attenuations, such as those enabled by a perturbation component. In some example, the perturbation(s) may be provided in a fixed and/or known sequence, and may be measured (e.g., by a power meter) to identify if mapping of a fiber optic signal is being done correctly or not (i.e., if the attenuations are as expected).

In some examples, as illustrated in FIG. 7C, one or more protrusions 721-724 of a perturbation component 720 may be spaced (e.g., laterally) along a length of the perturbation component 720 such that each of the one or more protrusions 721-724 may be directed to impacting a particular fiber. In particular, in some examples, the protrusions 721, 722 may be located to engage a first fiber 725, the protrusion 723 may be located to engage a second fiber 726, and the protrusion 724 may be located to engage a third fiber 727.

In particular, in some examples, the protrusion 721 may strike the first fiber 725 prior to the protrusion 723 striking the second fiber 726, and the protrusion 723 may strike the second fiber 726 prior to the protrusion 724 striking the third fiber 727. In this manner, in some examples, a detectable fiber mapping sequence may be provided.

It may be appreciated that the first fiber 725 being struck (first) by the protrusion 721 and (next) the protrusion 722 (e.g., a predetermined time period) may also provide a unique, detectable sequence as well. Specifically, in some examples, one or more of the protrusions 721-724 of the perturbation component 720 may be arranged to engage a fiber sequentially and/or at particular times (e.g., relative to each other) to create a unique detectable fiber mapping sequence.

It may be appreciated that, in some examples, the perturbation component 700 may be included in a fiber testing apparatus. Specifically, in some examples, the perturbation component 700 may be included a fiber testing device that may also include a transmitter. In other examples, the perturbation component 700 may be implemented as a standalone component, separate from a transmitter or receiver.

Accordingly, in some instances, implementation of a perturbation component (e.g., the perturbation component 700) as described herein may alleviate a need for precision during fiber mapping, such as that required by a switch. Moreover, implementation of the perturbation component may be relatively cost-effective option, and may be implemented without interrupting signal propagation through a fiber, and may be implemented to not inhibit communications over the fiber as well.

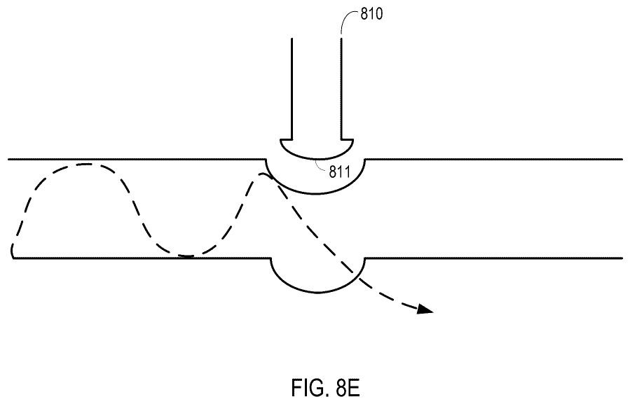

As discussed above, the systems and methods described herein may implement a variety of perturbation components to produce attenuation in fiber optic signal transmission to enable, among other things, signal transmission and fiber mapping. FIGS. 8A-8D illustrate aspects of another perturbation component 800, according to examples of the present disclosure. In some examples, the perturbation component 800 may include a supporting component 801 and a pressing component 802.

In some examples, the supporting component 801 may be used to house one or more fibers (e.g., of a multi-fiber bundle), as illustrated in FIG. 8A. In some examples, the supporting component 801 may take the form of a bobbin, while in other examples, the supporting component 801 may take the form of a spindle. Also, in some examples, the pressing component 802 may be located proximately close enough to the supporting component 801 so as to apply pressure to the body of the supporting component 801 and/or cause the one or more fibers to bend. In some examples, the pressing component 802 may take the form of a paddle, while in other examples, the pressing component 802 may take the form of a post or a (toothed) gear.

FIG. 8B illustrates a side view of the perturbation component 800, according to examples of the present disclosure. Specifically, FIG. 8B illustrates the supporting component 801 and the pressing component 802 in a rest/reference position, where the pressing component 802 is configured in way that causes no or minimal bending in the one or more fibers housed by the supporting component 801.

FIG. 8C illustrates a side view of a perturbation component 800, according to examples of the present disclosure. In particular, FIG. 8C illustrates the supporting component 801 and the pressing component 802 in an attenuated position, where the pressing component is configured in way that causes a bending in a first direction in the one or more fibers housed by the supporting component. In some examples, the pressing component 802 (e.g., a paddle) may be moved (e.g., via a motor or an actuator) to impart pressure on to the supporting component 801, causing the supporting component 801 to move (e.g., rotate clockwise), and to further cause a bending in the one or more fibers. In some examples, the bending in the one or more fibers may be associated with a first position of the supporting component 801, and may be referred to as an “attenuated position.” In some examples, the pressing component 802 may be spring-loaded, wherein upon release of the spring, the pressing component may return to a rest position (e.g., as illustrated in FIG. 8B).

FIG. 8D illustrates a side view of the perturbation component 800, according to examples of the present disclosure. Specifically, FIG. 8D illustrates the supporting component 801 and the pressing component 802 in a return attenuated position, where the pressing component is configured in way that causes a bending in a second direction in the one or more fibers housed by the supporting component. In some examples, the pressing component 802 (e.g., a paddle) may be moved (e.g., via a motor or an actuator) in a reverse direction to impart pressure on to the supporting component 801, causing the supporting component 801 to move (e.g., rotate counter-clockwise) in the reverse direction (e.g., away from the attenuated position), and further to cause a (reverse) bending in the one or more fibers. In some examples, the bending in the one or more fibers may be associated with a second position of the supporting component 801, and may be referred to as a “return attenuated position.”

It may be appreciated that, in this manner and according to the examples described herein, any (first) attenuation caused by a directed bending to an first or attenuated position, and any (second) attenuation caused by a directed bending to a second or return attenuated position may be utilized individually, in combination, or in concert (e.g., over a particular time period) to identify one or more fiber optic signals. Furthermore, it may be appreciated that the supporting component 801 and the pressing component 802 may take various similar forms, including any form that may facilitate an attenuation in fiber optic signal transmission as described herein.

In addition, it may be appreciated that, in some instances, to enable a directed bending in the one or more fibers, the pressing component 802 may bend a first portion of the one or more fibers, while not bending the remaining portion of the one or more fibers. Thereafter, in returning to the return attenuated position, the pressing component 802 may bend the remaining portion of the one or more fibers, while not bending the first portion of the one or more fibers. In some examples, this may be referred to as a “sequential bending” of a portion of the one or more fibers.

In some examples, the supporting component 801 and the pressing component 802 may be a part of an array of supporting components and pressing components, wherein the movement of each of the supporting components and pressing components may provide directed bending(s) in one or more fibers, in order to identify various fiber optical signals propagating through the one or more fibers. That is, in some examples, each of the supporting components in the array may be coupled respectively to a movable component (e.g., an actuator or motor) that may enable a particular and/or respective directed bending in each of the one or more fibers in a predetermined and/or sequential manner, in order to enable identification of each respective fiber optic signal.

It may be appreciated that a perturbation component as described herein may take other forms as well. FIG. 8E illustrates a curve-ended body 810 that may be implemented to apply pressure (i.e., press) a fiber into a (e.g., particular) form on or more sides of a fiber. In some examples, the curve-ended body 810 may include a curved end 811. Also, in some examples, a shape of the curved-ended body 810 may resemble a shape of a plunger having a rounded tip.

Specifically, by applying pressure to a first side of the fiber, the curve-ended body 810 may cause a directed bending on the first side of the fiber. In other example, the curve-ended body 810 may cause a directed bending on the first side of the fiber and an opposing side of the fiber. In some examples, the curve-ended body 810 may be moved to apply pressure via an actuator.

It may be appreciated that a curve-ended body, such as the curve-ended body 810, may be implemented to apply pressure to one or more fibers simultaneously. Furthermore, in some examples, a plurality of curve-ended bodies may be implemented in concert (e.g., spaced apart) to apply pressure to any number or all fibers in a fiber bundle. That is, similar to the examples described above, the one or more curve-ended may be applied in concert, sequentially, and/or in a time-specific fashion to create one or more unique detectable fiber mapping sequences.

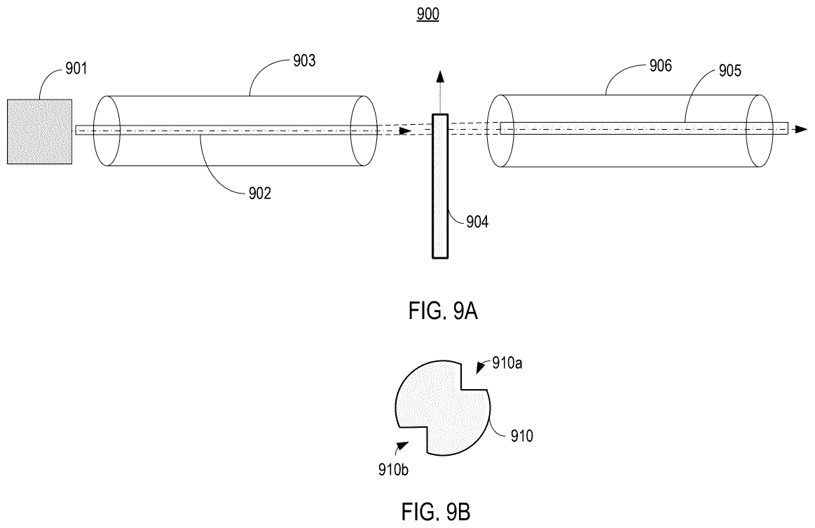

FIGS. 9A-9B illustrate aspects of a system 900 including a perturbation component, according to examples of the present disclosure. FIG. 9A illustrates an example where a perturbation component 904 may be a filter component, according to examples described herein.

FIG. 9A illustrates a light source 901 that emits a fiber optic signal 902 towards a first fiber 903. In some examples, the light source 901 may be a laser. Upon traveling through the first fiber 903, the fiber optic signal 902 may be exposed to an air gap. The air gap may have a distance d, wherein (in some examples) the distance d may be predetermined. In some examples, the air gap may be located in between the first fiber 903 and a second fiber 906.

In some examples, as the fiber optic signal 902 may propagate the air gap, it may be exposed to the perturbation component 904, wherein the perturbation component 904 may cause an attenuation in the fiber optic signal 902. Specifically, in passing through a filter, the fiber optic signal 902 may be attenuated, thereby enabling identification of the fiber optic signal 902 as described herein.

In some examples, a filter may include an anti-reflective (e.g., infrared blocking) coating on one or more sides of the filter, so as to block a portion of the fiber optic signal 902 as it may pass through the filter (i.e., perturbation). The fiber optic signal 902 may travel the distance d of the air gap, and may approach the second fiber 906, wherein the fiber optic signal 902 may be captured by the second fiber 906, and resulting in the (attenuated) fiber optic signal 905 propagating through the second fiber 906.

In some examples, the perturbation component 904 may be a movable filter that may be moved (e.g., perpendicularly to the path of the fiber optic signal 902) to filter, partially filter, or not filter the fiber optic signal 902. Specifically, in some examples, the filter may be moved via implementation of an actuator, while in other examples, the filter may be moved via implementation of a motor. In some examples, the filter may be an electronic filter, wherein the filtering characteristics of the filter may be programmable. It may be appreciated that, in various examples as described herein and in this manner, one or more filters may be moved to filter one or more fiber optic signals associated with one or more fibers.

Moreover, in some examples, the filter may be provided to enable various aspects of filtering, such a type of filtering or degree of filtering. So, in some examples, filtering characteristics of the filter may vary (i.e., may not be uniform). In particular, in some examples, the filtering characteristics of the filter may vary along the length of the filter, such that as the filter may be moved to filter the fiber optic signal 902, the filtering may vary according to the portion of the filter that the fiber optic signal 902 may be exposed to. It may be appreciated that such an arrangement may cause a varying attenuation, which may be used to identify the fiber optic signal 902.

In some examples, the filter may include a portion where no filtering takes place, such that the fiber optic signal may be filtered, unfiltered (as it passes the portion of the filter where no filtering takes place), and then filtered again. In other examples, the filter may include a portion where filtering takes place, wherein for a majority of the filter's length or range, no filtering takes place. In these examples, the fiber optic signal may be unfiltered, filtered (as it passes the portion of the filter where filtering takes place), and then unfiltered again.

In other examples, the filter may be stationary. That is, instead of using a movable filter where the movement of the filter exposes the fiber optic signal to varying filtering characteristics (i.e., perturbations), as described above, the systems and methods described herein may also cause perturbation via implementation of stationary filters where no movement of the filter (e.g., positionally with respect to a first and/or second fiber) is necessary.

So, in some examples, the filter may be held stationary (in place) in between a first fiber and a second fiber to filter the fiber optic signal. In some examples, the stationary filter may be activated, wherein a fiber optic signal passing through the filter may be filtered according to a constant or varying filtering characteristics. In some examples, the filter may be an electronic filter, wherein the filtering characteristics of the filter may be programmable.

Another example of a filter that may be implemented to cause perturbation is illustrated in FIG. 9B. In some examples, the perturbation component 910 may be a rotatable component. Specifically, the perturbation component 910 but may rotate on an axis, but may remain stationary in location with respect to the first fiber 903 and the second fiber 906.

In some examples, the perturbation component 910 may include one or more cropped portions 910a-910b, which may be used to effect attenuation(s) in a fiber optic signal that may be passed through. That is, in some examples, the perturbation component 910 may be rotated (e.g., via implementation of a motor), wherein the fiber optic signal may be intermittently interrupted and passed through via the one or more cropped portions 910a-910b.

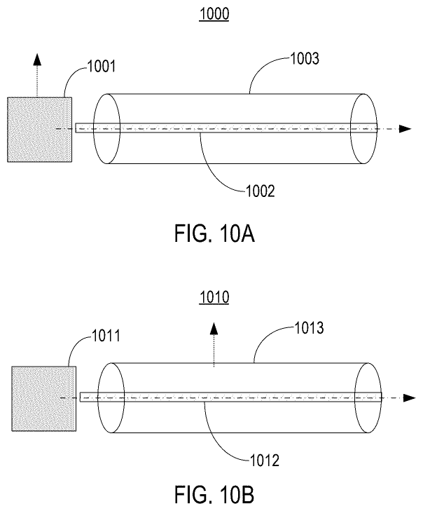

In some examples, in addition to altering aspects of a propagating fiber optic signal in order to distinctively identify a particular fiber optic signal and enable fiber mapping, the systems and methods described herein may also implement perturbation techniques associated with an optical source and/or an optical fiber as well. FIGS. 10A-10B illustrate systems 1000, 1010 having optical sources and optical fibers configured to enable distinctive identification of a fiber optic signal, according to examples described herein.

FIG. 10A illustrates a light source 1001 that transmits a fiber optic signal 1002 towards a fiber 1003. In some examples, the light source 1001 is a laser. In some examples, the light source 1001 may be movable, in that it may be slid across and over the fiber optic signal 1002 during transmission. By moving the light source 1001 as the light source 1001 transmits the fiber optic signal 1002 through the fiber 1003, a perturbation in the fiber optic signal 1002 may be created that may be used to identify the fiber optic signal 1002 at a destination.

FIG. 10B illustrates a light source 1011 that transmits a fiber optic signal 1012 towards a fiber 1013. In some examples, the light source 1011 is a laser. In some examples, the fiber 1013 may be movable, in that it may be slid across and over the light source 1011 during transmission. By moving the fiber 1013 as the light source 1011 may transmit the fiber optic signal 1012 through the fiber 1013, a perturbation in the fiber optic signal 1012 may be created that may be used to identify the fiber optic signal 1012 at a destination.

It may be appreciated that while the examples illustrated FIGS. 10A-10B are directed to a single light source and a single fiber, other examples of systems and methods described may implement these techniques with respect to a plurality of light sources and/or a plurality of fibers. For example, in some instances, a single light source may be moved across a multi-fiber bundle so as to illuminate fibers of the multi-fiber bundle in a sequential pattern in a predetermined and/or identifiable manner.

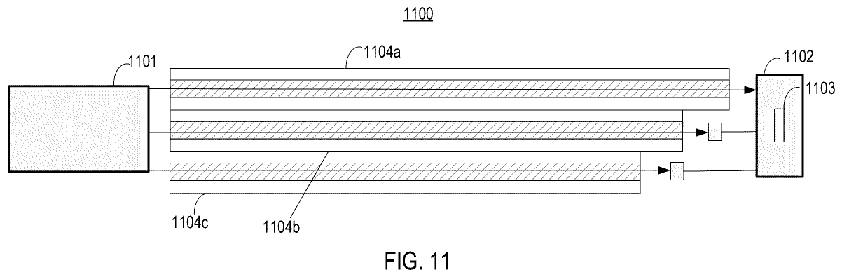

FIG. 11 illustrates a system 1100 wherein a plurality of fibers having different lengths are implemented to enable distinctive identification of a fiber optic signal, according to examples described herein. In some examples, a transmitter 1101 may transmit a plurality of fiber optic signals over a multi-fiber bundle including the fibers 1104a-1104c towards a receiver 1102. In some examples, the receiver 1102 may include a power meter 1103.

In some examples, each of the fibers 1104a-1104c may have a different length, which may enable implementation of time delay(s) in arrivals of a fiber optic signal at the receiver 1102. So, in the example illustrated in FIG. 11, arrival of a fiber optic signal from (longest) fiber 1104a will be delayed when compared to arrival of a fiber optic signal from fiber 1104b, and arrival of a fiber optic signal from fiber 1104b will be delayed when compared to arrival of a fiber optic signal from (shortest) fiber 1104c. In this manner, a fiber length and an associated time delay may be implemented to detect whether a particular fiber optic signal is propagating over a (correct) fiber.

In some examples, systems and methods described herein may implement addition of (particular) wavelengths of light to enable distinctive identification of a fiber optic signal. So, in examples where one or more light sources may be propagating one or more fiber optic signals over one or more fibers, the light source(s) may emit additional light content for the purpose of indicating and identifying a particular fiber optic signal and/or fiber.

In some instances, the additional light content may be inserted or “spliced” (i.e., a perturbation) to propagate in conjunction with another fiber optic signal. Moreover, in some examples, the additional light content may be emitted at particular and predetermined wavelengths, and the light energy at these wavelengths may be detected by a receiver (e.g., including a power meter). It may be appreciated that additional light from more than wavelength may be implemented as well.

In one example, a fiber that may be propagating a first fiber optic signal at fifteen-hundred fifty (1550) nanometers (nm) may also transmit a second fiber optic signal at thirteen-hundred ten (1310) nanometers (nm). In this example, based on the presence of the second fiber optic signal (i.e., propagating at thirteen-hundred ten (1310) nanometers (nm)), the systems and methods described herein may identify a particular fiber and/or the first fiber optic signal.

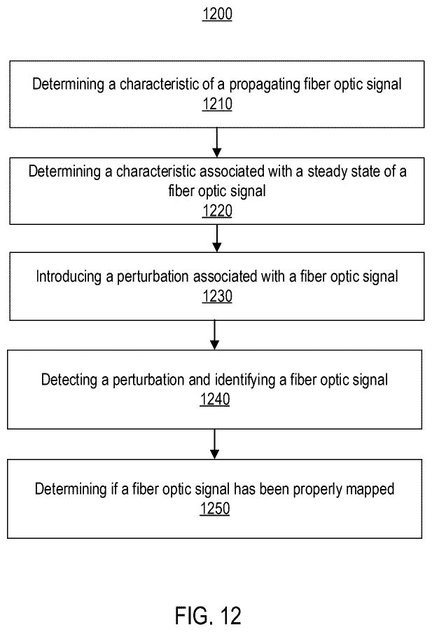

FIG. 12 illustrates a method for implementing perturbation techniques in an optical system to enable fiber mapping, according to examples of the present disclosure. The method 1200 is provided by way of example, as there may be a variety of ways to carry out the method described herein. Each block shown in FIG. 12 may further represent one or more processes, methods, or subroutines, and one or more of the blocks may include machine-readable instructions stored on a non-transitory computer-readable medium and executed by a processor or other type of processing circuit to perform one or more operations described herein. It may be appreciated that the systems and methods described herein, and in particular the various techniques described above, may be combined in various manners to implement perturbation techniques and/or enable fiber mapping.

In some examples, the method 1200 may be executed or otherwise performed by other systems, or a combination of systems. Furthermore, in some examples, the systems and methods described herein may include a testing device for testing conditions associated with a data center, comprising an input/output (I/O) device comprising a display, a processor, a memory to store machine readable instructions executable by the processor to capture first data associated with signal activity a communications link (e.g., a fiber optic link).

Reference is now made with respect to FIG. 12. At 1210, the method may include propagating a fiber optic signal over a fiber. In some examples, the fiber optic signal may be propagated via a light source, such as a laser or an LED.

At 1220, the method may determining one or more characteristics associated with a steady state of a propagating fiber optic signal. In some examples, this may include determining one or more wavelengths associated with the propagating fiber optic signal. In other examples, this may include determining an optic power of the propagating fiber optic signal.

At 1230, the method may include introducing a perturbation associated with a propagating fiber optic signal. In some examples, the perturbation may include introduction of an attenuation in a fiber optic signal. In other examples, the perturbation may include filtering of a fiber optic signal. In still other examples, the perturbation may include movement) of one or more of an optical source or a fiber.

At 1240, the method may include detecting of a perturbation and identification of a fiber optic signal. Specifically, upon perturbation of the fiber optic signal, aspects of (perturbed) fiber optic signal may be measured. For example, in some instances, the (perturbed) fiber optic signal may be measured by power meter (e.g., on a receiver) to determine an attenuation in the fiber optic signal.

At 1250, the method may include a determination if a fiber optic signal has been properly mapped. Specifically, in some examples, results from measuring the (perturbed) fiber optic signal may be used to determine if the fiber optic signal is being transmitted on a correct fiber (i.e., fiber mapping).

In some examples, the systems and methods described herein include an apparatus, comprising a transmitter to transmit a fiber optic signal from a port of the transmitter through a fiber, a fiber perturbation component to provide perturbation of the fiber optic signal during propagation through the fiber, and a receiver to receive the fiber optic signal at a port of the receiver, wherein the receiver is to detect and analyze the perturbation of the fiber optic signal to determine if the port of the receiver is an appropriate port for the fiber optic signal to be mapped to. In some examples, the transmitter comprises the fiber perturbation component, the transmitter is to transmit the fiber optic signal according to a predetermined steady state of the fiber optic signal, and the transmitter is to send one or more of information related to the predetermined steady state and the perturbation of the fiber optic signal over a communication channel coupling the transmitter and the receiver. In some examples, the perturbation includes introducing an attenuation in the fiber optic signal, the detecting and analyzing the perturbation of the fiber optic signal includes determining a deviation from a steady state, and the fiber perturbation component includes a movable perturbation component in contact with the fiber, wherein the movable perturbation component includes one or more protrusions. In some examples, the one or more protrusions are contacted against a surface of the fiber to cause a directed bending of the fiber, and the fiber perturbation component includes a supporting component to support the fiber, and a pressing component to apply pressure to the supporting component to move the supporting component, wherein movement of the supporting component causes a directed bending of the fiber. In some examples, the fiber perturbation component includes a filter component to move across a path of the fiber optic signal to produce an attenuation of the fiber optic signal while propagating through the fiber.

In some examples, the systems and methods described herein include a method for implementing perturbation techniques in an optical system to enable fiber mapping, comprising transmitting a fiber optic signal from a first port through a fiber, determining one or more characteristics associated with a steady state of the fiber optic signal, providing a perturbation associated with the fiber optic signal, detecting and analyzing the perturbation associated with the fiber optic signal, identifying, based on the perturbation, the fiber optic signal, and determining if the fiber optic signal is mapped from the first port to a second port. In some examples, the method may further include sending one or more of information related to the steady state and the perturbation of the fiber optic signal over a communication channel coupling the first port and the second port, and the perturbation includes an attenuation in the fiber optic signal. In some examples, the attenuation is effected by a directed bending of the fiber, and the detecting and analyzing the perturbation of the fiber optic signal includes determining a deviation from a steady state.

In some examples, the systems and methods described herein include a non-transitory computer readable medium configured to store instructions, when executed by a processor, cause the processor to perform steps comprising transmit a fiber optic signal through a fiber, determine one or more characteristics associated with a steady state of the fiber optic signal, provide a perturbation associated with the fiber optic signal, detect and analyze the perturbation associated with the fiber optic signal, identify, based on the perturbation, the fiber optic signal, and determine a mapping for the fiber optic signal. In some examples, the instructions, when executed by the processor, cause the processor to send one or more of information related to the steady state and the perturbation of the fiber optic signal over a communication channel. In some examples, to detect and analyze the perturbation associated with the fiber optic signal, the instructions, when executed by the processor, cause the processor to determine a deviation from a steady state. In some examples, to provide a perturbation associated with the fiber optic signal, the instructions, when executed by the processor, cause the processor to provide an attenuation in the fiber optic signal via a directed bending of the fiber, and to detect and analyze the perturbation associated with the fiber optic signal, the instructions, when executed by the processor, cause the processor to implement a power meter to determine a power level of the fiber optic signal.

What has been described and illustrated herein is an example along with some of its variations. The terms, descriptions and figures used herein are set forth by way of illustration only and are not meant as limitations. Many variations are possible within the spirit and scope of the subject matter, which is intended to be defined by the following claims—and their equivalents—in which all terms are meant in their broadest reasonable sense unless otherwise indicated.

1. An apparatus, comprising:
a transmitter to transmit a fiber optic signal from a port of the transmitter through a fiber;
a fiber perturbation component to provide perturbation of the fiber optic signal during propagation through the fiber; and
a receiver to receive the fiber optic signal at a port of the receiver, wherein the receiver is to detect and analyze the perturbation of the fiber optic signal to determine if the port of the receiver is an appropriate port for the fiber optic signal to be mapped to.

2. The apparatus of claim 1, wherein the transmitter comprises the fiber perturbation component.

3. The apparatus of claim 1, wherein the transmitter is to transmit the fiber optic signal according to a predetermined steady state of the fiber optic signal.

4. The apparatus of claim 3, wherein the transmitter is to send one or more of information related to the predetermined steady state and the perturbation of the fiber optic signal over a communication channel coupling the transmitter and the receiver.

5. The apparatus of claim 1, wherein the perturbation includes introducing an attenuation in the fiber optic signal.

6. The apparatus of claim 5, wherein detecting and analyzing the perturbation of the fiber optic signal includes determining a deviation from a steady state.

7. The apparatus of claim 1, wherein the fiber perturbation component includes a movable perturbation component in contact with the fiber, wherein the movable perturbation component includes one or more protrusions.

8. The apparatus of claim 7, wherein the one or more protrusions are contacted against a surface of the fiber to cause a directed bending of the fiber.

9. The apparatus of claim 1, wherein the fiber perturbation component includes:
a supporting component to support the fiber; and
a pressing component to apply pressure to the supporting component to move the supporting component, wherein movement of the supporting component causes a directed bending of the fiber.

10. The apparatus of claim 1, wherein the fiber perturbation component includes a filter to move across a path of the fiber optic signal to produce an attenuation of the fiber optic signal while propagating through the fiber.

11. A method for implementing perturbation techniques in an optical system to enable fiber mapping, comprising:
transmitting a fiber optic signal from a first port through a fiber;
determining one or more characteristics associated with a steady state of the fiber optic signal;
providing a perturbation associated with the fiber optic signal;
detecting and analyzing the perturbation associated with the fiber optic signal;
identifying, based on the perturbation, the fiber optic signal; and
determining if the fiber optic signal is mapped from the first port to a second port.

12. The method of claim 11, including sending one or more of information related to the steady state and the perturbation of the fiber optic signal over a communication channel coupling the first port and the second port.

13. The method of claim 11, wherein the perturbation includes an attenuation in the fiber optic signal.

14. The method of claim 13, wherein the attenuation is effected by a directed bending of the fiber.

15. The method of claim 11, wherein detecting and analyzing the perturbation of the fiber optic signal includes determining a deviation from a steady state.

16. A non-transitory computer readable medium configured to store instructions, when executed by a processor, cause the processor to perform steps comprising:
transmit a fiber optic signal through a fiber;
determine one or more characteristics associated with a steady state of the fiber optic signal;
provide a perturbation associated with the fiber optic signal;
detect and analyze the perturbation associated with the fiber optic signal;
identify, based on the perturbation, the fiber optic signal; and
determine a mapping for the fiber optic signal.

17. The non-transitory computer readable medium of claim 16, wherein the instructions, when executed by the processor, cause the processor to send one or more of information related to the steady state and the perturbation of the fiber optic signal over a communication channel.

18. The non-transitory computer readable medium of claim 16, wherein to detect and analyze the perturbation associated with the fiber optic signal, the instructions, when executed by the processor, cause the processor to determine a deviation from a steady state.

19. The non-transitory computer readable medium of claim 16, wherein, to provide a perturbation associated with the fiber optic signal, the instructions, when executed by the processor, cause the processor to provide an attenuation in the fiber optic signal via a directed bending of the fiber.

20. The non-transitory computer readable medium of claim 16, wherein, to detect and analyze the perturbation associated with the fiber optic signal, the instructions, when executed by the processor, cause the processor to implement a power meter to determine a power level of the fiber optic signal.
